(19) United States
(12) Patent Application Publication
(10) Pub. No.: US 2026/0099758 A1
(43) Pub. Date: Apr. 9, 2026

(54) ITERATIVE TECHNIQUE TO IDENTIFY GLOBAL MINIMUM IN A DATASET

(71) Applicant: Salesforce, Inc., San Francisco, CA (US)

(72) Inventors: Bikramaditya Padhi, Bangalore (IN); Ramprasadh Kothandaraman, Hyderabad (IN)

(21) Appl. No.: 18/906,974

(22) Filed: Oct. 4, 2024

(51) Int. Cl. G06N 20/00

(52) U.S. Cl. CPC G06N 20/00

(57) ABSTRACT

An application server may receive a request to train the machine learning model on a dataset, and may generate a first set of randomized solutions based on inputting one or more of a set of model parameters into the machine learning model, where the first set of randomized solutions correspond to a set of outputs generated by the machine learning model and spans at least a subset of a set of local minimums. The application server may then select a first solution from the first set of randomized solutions and generate a second set of randomized solutions based on the first solution and inputting one or more of the set of model parameters into the machine learning model. The application server may then determine that the second set of randomized solutions includes a global minimum of the dataset based on the second set of randomized solutions satisfying a threshold.

### FIELD OF TECHNOLOGY

The present disclosure relates generally to database systems and data processing, and more specifically to an iterative technique to identify global minimum in a dataset.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a data processing system that supports an iterative technique to identify global minimum in a dataset in accordance with aspects of the present disclosure.

FIG. 2 shows an example of a computing system that supports an iterative technique to identify global minimum in a dataset in accordance with aspects of the present disclosure.

FIG. 3 shows an example of a process flow that supports an iterative technique to identify global minimum in a dataset in accordance with aspects of the present disclosure.

FIG. 4 shows a block diagram of an apparatus that supports an iterative technique to identify global minimum in a dataset in accordance with aspects of the present disclosure.

FIG. 5 shows a block diagram of a model training component that supports an iterative technique to identify global minimum in a dataset in accordance with aspects of the present disclosure.

FIG. 6 shows a diagram of a system including a device that supports an iterative technique to identify global minimum in a dataset in accordance with aspects of the present disclosure.

FIGS. 7 through 10 show flowcharts illustrating methods that support an iterative technique to identify global minimum in a dataset in accordance with aspects of the present disclosure.

### DETAILED DESCRIPTION

A machine learning model may be trained using a set of variables derived from real world data that may correspond to an output. Training a machine learning model may be equivalent to finding a mathematical function that fits an observed output. For instance, a machine learning model (e.g., gradient-based methods, like Gradient Descent (GD), Particle Swarm Optimization (PSO), Momentum, Adagrad, and RMSprop) may be trained using a difference between an original output (e.g., original value) and an observed output (e.g., observed output upon inputting one or more variables in the machine learning model). The difference between the outputs may be measured as mean squared error (MSE) in accordance with the following equation:

$$MSE = \frac{1}{N} {\sum }_{i = 1}^{N} {( {y}_{i} - {y}_{i}^{\hat{}} )}^{2} \qquad Equation ( 1 )$$

As described with reference to Equation 1, the minimum value of this function may imply that a difference between observed and calculated outputs are minimum. Some optimization techniques, however, may be inefficient and may get stuck with a local minima, in particular when the data set is large with multiple local minima. As such, without identifying a global minima these methods may fail or may converge to suboptimal solutions.

One or more aspects of the present disclosure provide for a method for identifying a global minima in the context of loss function for training a machine learning model. In some examples, an application server may implement an algorithm for identifying a global minima over a data set. The first step of the algorithm may include random initialization, where the algorithm may start by generating a set of random solutions within a search space. The algorithm may then evaluate the solutions generated by the random initialization by computing a loss for each solution using a given loss function (e.g., Equation 1). In some examples, the algorithm may then select the solution with the lowest loss among the current set. For instance, the algorithm may identify a local minima. The algorithm, next, may use the current local minima to generate new solutions around the selected solution. For example, the algorithm may generate new solutions around the solution with lowest loss by adding small random perturbations. In some cases, the algorithm may iteratively perform this process for a threshold quantity of iterations or until a convergence criteria is met. The algorithm may determine convergence by checking if the average change in the solutions is below a defined tolerance level. Thus, implementing the techniques depicted herein, the application server may identify a global minima in a dataset.

Aspects of the disclosure are initially described in the context of an environment supporting an on-demand database service. Aspects of the disclosure are further illustrated by and described with reference to a computing system and a process flow. Aspects of the disclosure are further illustrated by and described with reference to apparatus diagrams, system diagrams, and flowcharts that relate to an iterative technique to identify global minimum in a dataset.

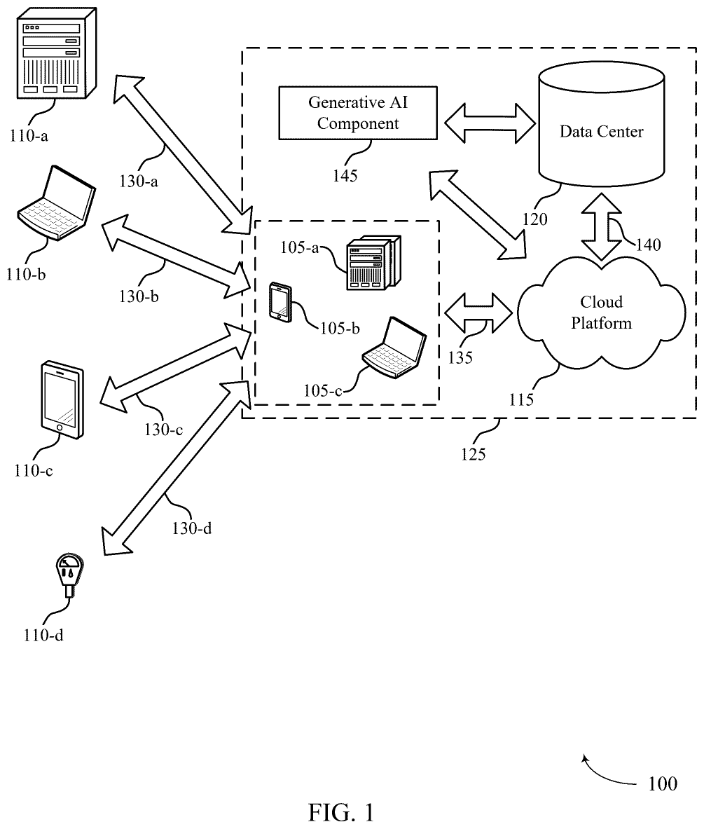

FIG. 1 illustrates an example of a system 100 for cloud computing that supports an iterative technique to identify global minimum in a dataset in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, when training a machine learning model, an application server may attempt to find a global minima. However, some techniques may be inefficient and may get stuck with local minima, especially when the data set is large with multiple local minima. Some gradient-based methods (e.g., GD, PSO, Momentum, Adagrad, and RMSprop) may encounter difficulties in such scenarios due to their reliance on gradient information. Noisy or unavailable gradients can cause these methods to fail or converge to suboptimal solutions.

According to one or more aspects of the present disclosure, the subsystem 125 may receive, from a user and at an interface for accessing a machine learning model, a request to train the machine learning model on a dataset by iteratively inputting a set of model parameters into the machine learning model to minimize a loss function associated with the dataset. In some examples, the dataset may include a set of local minimums. The subsystem 125 may generate a first set of randomized solutions based on inputting one or more of the set of model parameters into the machine learning model. In some examples, the first set of randomized solutions may correspond to a set of outputs generated by the machine learning model upon inputting the set of model parameters. In some examples, the first set of randomized solutions may correspond to a set of outputs generated by the machine learning model and spans at least a subset of the set of local minimums. The subsystem 125 may select a first solution from the first set of randomized solutions. In some cases, the first solution may have a minimum loss value of a first set of loss values corresponding to the first set of randomized solutions. In some cases, the first solution may correspond to the at least one local minimum of the set of local minimums of the dataset. The subsystem 125 may generate a second set of randomized solutions based on the first solution and inputting one or more of the set of model parameters into the machine learning model, and may further determine that the second set of randomized solutions includes a global minimum of the dataset based on the second set of randomized solutions satisfying a threshold. The subsystem 125 may then provide for display, via the interface, an indication of completion of training of the machine learning model based on the second set of randomized solutions including the global minimum of the dataset. As such, the techniques described herein provide for improvements to the technology of machine learning training. Among the technical advantages of the described approaches is the increased efficiency and accuracy of the algorithm over existing approaches. By using the described techniques, machine learning models may be trained with fewer compute resources and the models themselves will perform with increased accuracy, leading to more accurate predictions and inferences by the model, among other advantages.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

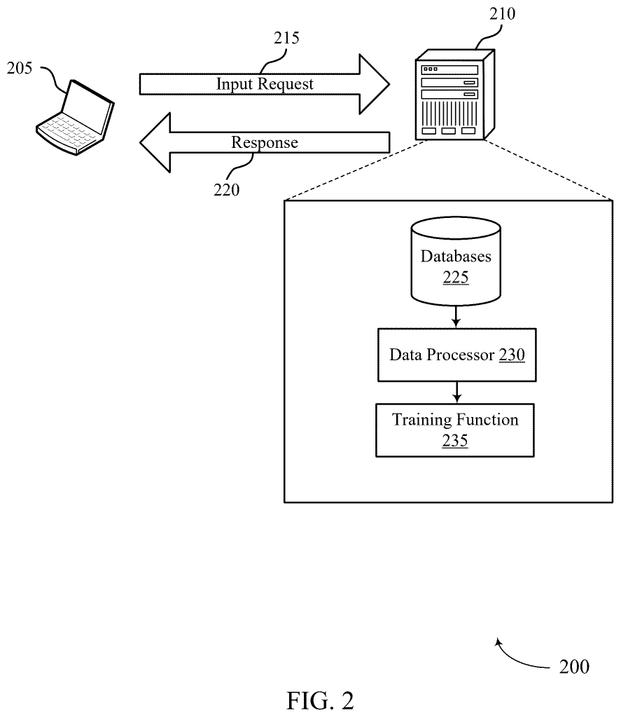

FIG. 2 shows an example of a computing system 200 that supports an iterative technique to identify global minimum in a dataset in accordance with aspects of the present disclosure. The computing system 200 includes a user device 205 and a server 210. The user device 205 may be an example of a device associated with a cloud client 105 or contact 110 of FIG. 1. The server 210 may be examples of aspects of the cloud platform 115 and the data center 120 of FIG. 1. For example, the server 210 may be represent various devices and components that support an analytical data system as described herein. The server 210 may support a multi-tenant database system, which may manage various databases 225 that are associated with specific tenants (e.g., cloud clients 105). The server 210 may also support training a machine learning model or running a machine learning model in response to an input request 215 received from user devices, such as user device 205. A response to an input request 215 may be surfaced to a user at the user device 205.

As described, the server 210 may manage various databases 225 that are associated with specific tenants. For example, a database 225 (or other datastore) may store a set of datasets that are associated with the tenant corresponding to user device 205. The server 210 may support training of a machine learning model using an iterative procedure. To support training of the machine learning model described herein, a data preprocessor 230 may identify a dataset on which the machine learning model is to be trained. The data preprocessor 230 may train a machine learning model using a training function 235.

In some examples, the server 210 may implement a coin collection optimization (CCO) method to train a machine learning model on large data sets where a large number of local minima are present. Particularly, in machine learning, there may be a set of variables and an output that is observed in real world data. Training a machine learning model may be equivalent to finding a mathematical function that fits an observed output. When training a machine learning model, the server 210 may determine a difference between an original output (e.g., original value) and an observed output (e.g., observed output upon inputting one or more variables in the machine learning model). The difference between the outputs are measured as MSE in accordance with the following equation:

$$MSE = \frac{1}{N} {\sum }_{i = 1}^{N} {( {y}_{i} - {y}_{i}^{\hat{}} )}^{2} \qquad Equation ( 2 )$$

In such cases, a particular function may be identified as a trained model or solution or completion of training of the machine learning model. Subsequently, the particular function identified as the trained model may be used as the model for predicting future outputs. A dataset on which a machine learning model is trained may have multiple local minima. In some examples, one or more algorithms may be inefficient or may not be able to converge to a solution corresponding to a global minima (where MSE is the least). In some examples, some optimization techniques may be inefficient and may get stuck with local minima, particularly when the data set is large with multiple local minima. In some cases, one or more gradient-based methods may encounter difficulties in such scenarios due to their reliance on gradient information. Additionally, noisy or unavailable gradients can cause these methods to fail or converge to suboptimal solutions.

As depicted herein, the server 210 may support training a machine learning model in accordance with the CCO method. In some examples, a machine learning model (e.g., gradient-based machine learning models, GD, PSO, Momentum, Adagrad, and RMSprop) may be trained using a difference between an original output (e.g., original value) and an observed output (e.g., observed output upon inputting one or more variables in the machine learning model). The server 210 may identify an output with the least MSE that corresponds to a global minima of the dataset.

According to one or more aspects depicted herein, the server 210 may receive, from the user device 205, an input request 215. The input request 215 may correspond to a request to train the machine learning model on a dataset by iteratively inputting a set of model parameters into the machine learning model to minimize a loss function associated with the dataset. In some examples, the machine learning model may include a gradient-based machine learning model.

The dataset may be included in databases 225. The data preprocessor 230 may identify the dataset based on receiving the input request 215. As described herein, the loss function may include or correspond to the function described in Equation (2). In some examples, the dataset may include a set of local minimums. The server 210, upon receiving the request, may start the training method by generating a set of random solutions within a search space. For instance, the training function 235 may generate a first set of randomized solutions based on inputting one or more of the set of model parameters into the machine learning model. In some examples, the first set of randomized solutions may correspond to a set of outputs generated by the machine learning model upon inputting the set of model parameters. In some examples, the first set of randomized solutions may span at least a subset of the set of local minimums. In some examples, the training function 235 may generate the first set of loss values corresponding to the first set of randomized solutions based on computing a loss value for each randomized solution of the first set of randomized solutions using the loss function associated with the dataset.

The training function 235 may perform an evaluation of solutions after generating the first set of randomized solutions. For instance, the training function 235 may compute the loss for each solution using a given loss function. In some examples, the training function 235 may identify the solution with the lowest loss among the current set. The training function 235 may select a first solution from the first set of randomized solutions, where the first solution has a minimum loss value of a first set of loss values corresponding to the first set of randomized solutions. In some examples, the first solution may correspond to the at least one local minimum of the set of local minimums of the dataset.

In some examples, training function 235 may perform a local refinement process. The training function 235 may perform the local refinement process by generating new solutions around the selected solution (e.g., the solution with the lowest loss) by adding small random perturbations. For instance, the training function 235 may generate a second set of randomized solutions based on the first solution and inputting one or more of the set of model parameters into the machine learning model. In some examples, the training function 235 may generate a set of updated model parameters for inputting into the machine learning model based on adding one or more deviations to the set of model parameters. In some examples, the second set of randomized solutions may be generated within a threshold distance of a search space associated with the first solution. Additionally, or alternatively, the set of model parameters may be based on a dimensionality of a search space associated with the machine learning model.

The training function 235 may then use the set of updated model parameters to generate a second set of randomized solutions. In some examples, the training function 235 may determine that the second set of randomized solutions may include a global minimum of the dataset based on the second set of randomized solutions satisfying a threshold. The training function 235 may then repeat the evaluation, the selection, and the refinement steps for a threshold number of iterations or until convergence criteria are met. For example, the training function 235 may iteratively generate a set of randomized solutions for a first quantity iterations prior to generating the second set of randomized solutions. In some examples, the training function 235 may determine that the second set of randomized solutions includes the global minimum of the dataset based on the first quantity of iterations satisfying a threshold quantity of iterations.

In some examples, the training function 235 may perform a convergence check after generating a second set of randomized solution. In some examples, the training function 235 may determine convergence by checking whether an average change in the solutions is below a defined tolerance level. For instance, the training function 235 may calculate an average change between the first set of randomized solutions and the second set of randomized solutions. The training function 235 may determine that the second set of randomized solutions includes the global minimum of the dataset based on the average change being less than a threshold level. Once trained, the server 210 may transmit a response 220 providing for display, via the interface, an indication of completion of training of the machine learning model based on the second set of randomized solutions including the global minimum of the dataset.

According to one or more aspects of the present disclosure, the server 210 may implement the iterative process of training a machine learning model according to the following pseudo code.

def coin_collecting_optimization(loss_func, num_coins=100,
num_iters=100, region_size=0.1, tol=1e−6):
num_features = 2 # Dimensionality of the search space
# Randomly initialize coins (solutions)
coins = np.random.randn(num_coins, num_features)
best_solution = None
best_loss = float(‘inf’)
for iteration in range(num_iters):
# Evaluate the loss for each coin
losses = np.array([loss_func(coin) for coin in coins])
# Identify the best coin (solution with the lowest loss)
min_loss = np.min(losses)
best_coin = coins[np.argmin(losses)]
if min_loss < best_loss:
best_loss = min_loss
best_solution = best_coin
# Generate new coins around the best coin
coins = best_solution + np.random.uniform(−region_size, region_size,
(num_coins, num_features))
# Check for convergence
if np.linalg.norm(np.mean(coins, axis=0) − best_solution) < tol:
break
return best_solution

Thus, the iterative technique to identify global minimum in a dataset is implemented using random sampling and local refinement. The iterative technique may not reply on gradient information, which may allow for efficient navigation through functions with multiple local minima. In particular, the iterative technique depicted herein is robust in noisy environments and performs well in scenarios where other methods may be inefficient due to noisy gradient information. In some examples, the iterative technique to identify global minimum may be efficient on real-world applications with imperfect data (e.g., datasets having multiple local minima). Additionally, or alternatively, the iterative technique may be flexible and adaptable and may be applied to a wide range of optimization scenarios without extensive modifications. In some examples, the iterative techniques may adapt to the complexity of the problem by adjusting the number of samples and refinement iterations. Additionally, the iterative technique may utilize random sampling to explore the solution space broadly and may focus on local refinement to enhance the best-found solutions (e.g., solutions with minimum loss) iteratively. In some examples, the iterative technique described herein may be independent of gradient information and may be useful for optimization scenarios where gradients are noisy, discontinuous, or unavailable.

In some examples, the iterative technique to identify global minimum described in the present disclosure may be effective in navigating optimization landscapes with numerous local minima and may be less likely to get trapped in suboptimal solutions compared to gradient-based methods. The technique of combining random sampling with local refinement, independence from gradient information, and robustness in navigating complex datasets with numerous local minima, may result in enhanced user experience.

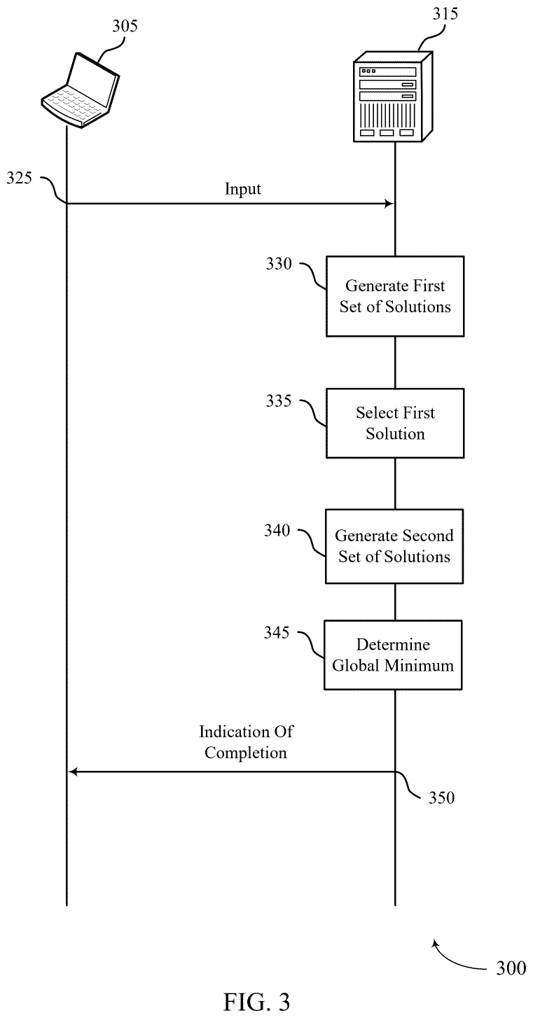

FIG. 3 shows an example of a process flow 300 that supports an iterative technique to identify global minimum in a dataset in accordance with aspects of the present disclosure. The process flow 300 may be implemented by an application server 315 and a user device 305, which may be examples of the corresponding devices and systems as described with respect to FIGS. 1 and 2.

In some examples, the operations illustrated in the process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 325, the application server 315 may receive, from the user device 305 and at an interface for accessing a machine learning model, a request to train the machine learning model on a dataset by iteratively inputting a set of model parameters into the machine learning model to minimize a loss function associated with the dataset. In some examples, the dataset may include a set of local minimums. In some examples, the machine learning model may include a gradient-based machine learning model.

At 330, the application server 315 may generate a first set of randomized solutions based on inputting one or more of the set of model parameters into the machine learning model. In some examples, the first set of randomized solutions may correspond to a set of outputs generated by the machine learning model upon inputting the set of model parameters, and the first set of randomized solutions may span at least a subset of the set of local minimums.

At 335, the application server 315 may select a first solution from the first set of randomized solutions. In some examples, the first solution may have a minimum loss value of a first set of loss values corresponding to the first set of randomized solutions. In some examples, the first solution may correspond to the at least one local minimum of the set of local minimums of the dataset.

At 340, the application server 315 may generate a second set of randomized solutions based on the first solution and inputting one or more of the set of model parameters into the machine learning model. At 345, the application server 315 may determine that the second set of randomized solutions includes a global minimum of the dataset based on the second set of randomized solutions satisfying a threshold.

At 350, the application server 315 may provide for display, via the interface, an indication of completion of training of the machine learning model based on the second set of randomized solutions including the global minimum of the dataset.

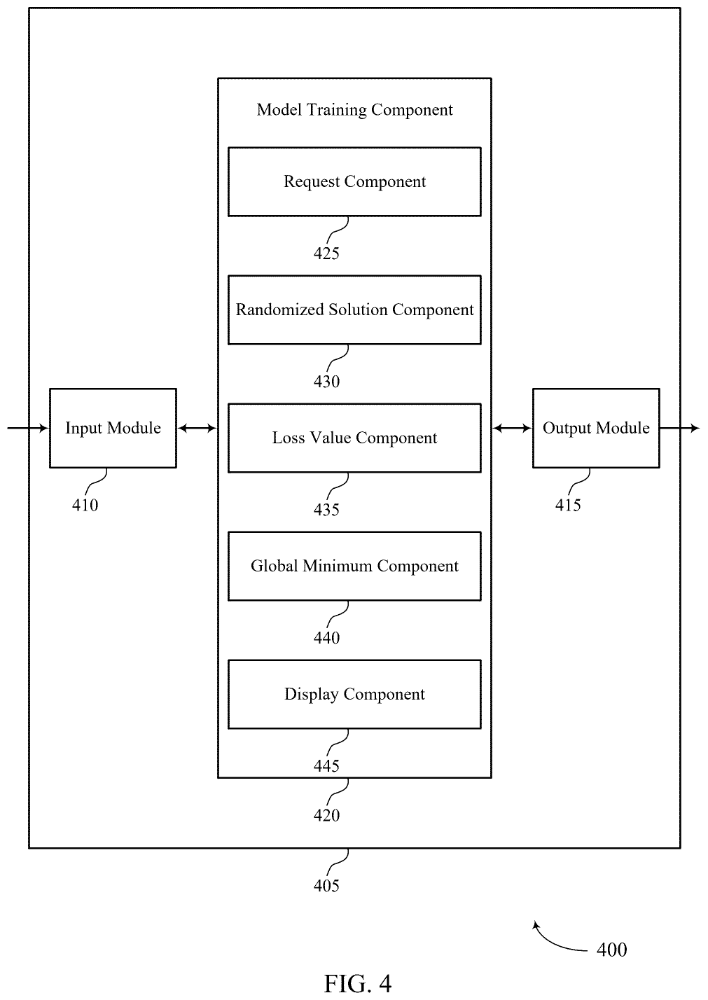

FIG. 4 shows a block diagram 400 of a device 405 that supports an iterative technique to identify global minimum in a dataset in accordance with aspects of the present disclosure. The device 405 may include an input module 410, an output module 415, and a model training component 420. The device 405, or one or more components of the device 405 (e.g., the input module 410, the output module 415, the model training component 420), may include at least one processor, which may be coupled with at least one memory, to support the described techniques. Each of these components may be in communication with one another (e.g., via one or more buses).

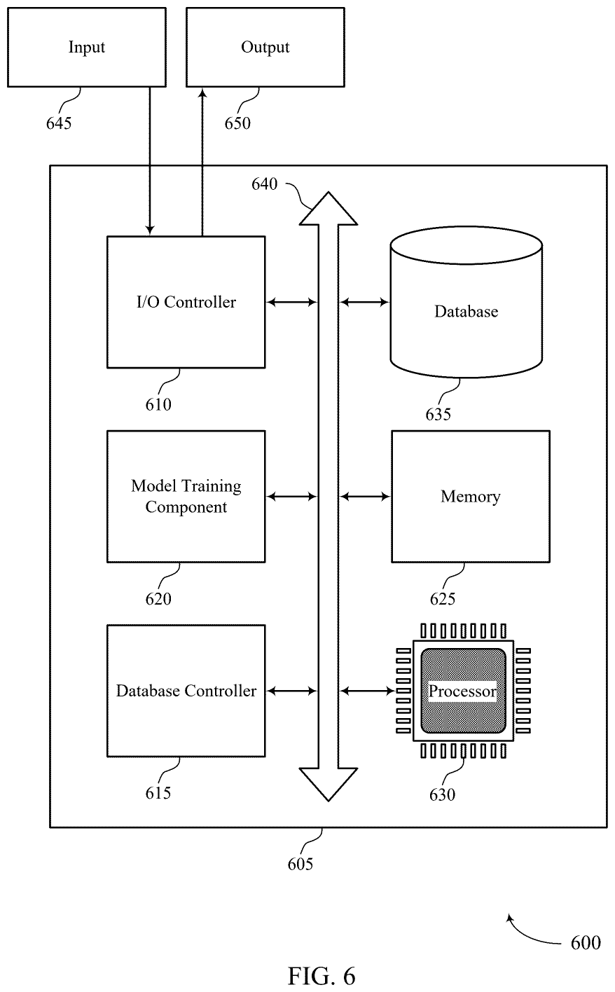

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the model training component 420 to support an iterative technique to identify global minimum in a dataset. In some cases, the input module 410 may be a component of an input/output (I/O) controller 610 as described with reference to FIG. 6.

The output module 415 may manage output signals for the device 405. For example, the output module 415 may receive signals from other components of the device 405, such as the model training component 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the model training component 420 may include a request component 425, a randomized solution component 430, a loss value component 435, a global minimum component 440, a display component 445, or any combination thereof. In some examples, the model training component 420, or various components thereof, may be configured to perform various operations (e.g., receiving, monitoring, transmitting) using or otherwise in cooperation with the input module 410, the output module 415, or both. For example, the model training component 420 may receive information from the input module 410, send information to the output module 415, or be integrated in combination with the input module 410, the output module 415, or both to receive information, transmit information, or perform various other operations as described herein.

The model training component 420 may support data processing in accordance with examples as disclosed herein. The request component 425 may be configured to support receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The randomized solution component 430 may be configured to support generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The loss value component 435 may be configured to support selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The randomized solution component 430 may be configured to support generating a second set of randomized solutions based on the first solution and inputting one or more of the set of model parameters into the machine learning model. The global minimum component 440 may be configured to support determining that the second set of randomized solutions includes a global minimum of the dataset based on the second set of randomized solutions satisfying a threshold. The display component 445 may be configured to support providing for display, via the interface, an indication of completion of training of the machine learning model based on the second set of randomized solutions including the global minimum of the dataset.

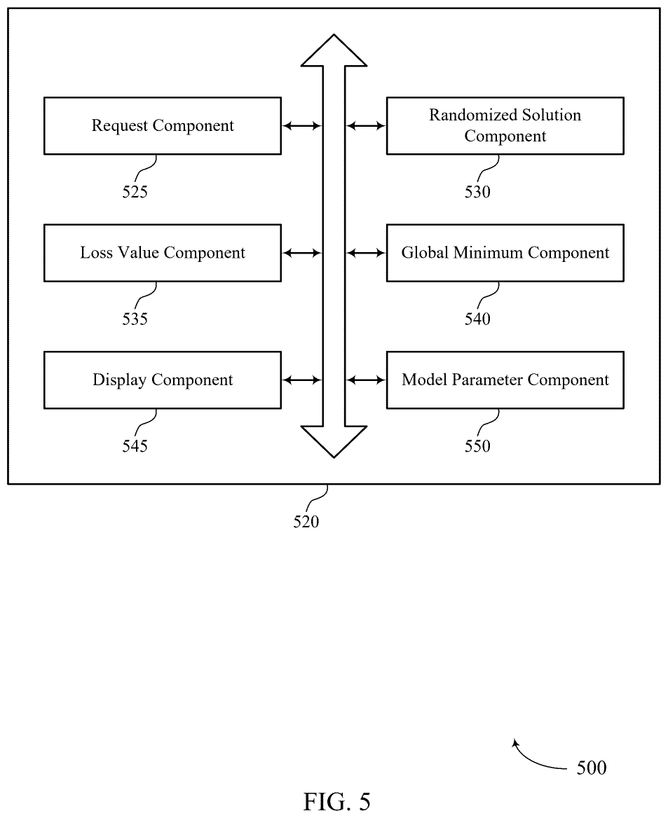

FIG. 5 shows a block diagram 500 of a model training component 520 that supports an iterative technique to identify global minimum in a dataset in accordance with aspects of the present disclosure. The model training component 520 may be an example of aspects of a model training component or a model training component 420, or both, as described herein. The model training component 520, or various components thereof, may be an example of means for performing various aspects of an iterative technique to identify global minimum in a dataset as described herein. For example, the model training component 520 may include a request component 525, a randomized solution component 530, a loss value component 535, a global minimum component 540, a display component 545, a model parameter component 550, or any combination thereof. Each of these components, or components of subcomponents thereof (e.g., one or more processors, one or more memories), may communicate, directly or indirectly, with one another (e.g., via one or more buses).

The model training component 520 may support data processing in accordance with examples as disclosed herein. The request component 525 may be configured to support receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The randomized solution component 530 may be configured to support generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The loss value component 535 may be configured to support selecting a first solution from the first set of randomized solutions, the first solution having a minimum loss value of a first set of loss values corresponding to the first set of randomized solutions, the first solution corresponding to the at least one local minimum of the set of multiple local minimums of the dataset. In some examples, the randomized solution component 530 may be configured to support generating a second set of randomized solutions based on the first solution and inputting one or more of the set of model parameters into the machine learning model. The global minimum component 540 may be configured to support determining that the second set of randomized solutions includes a global minimum of the dataset based on the second set of randomized solutions satisfying a threshold. The display component 545 may be configured to support providing for display, via the interface, an indication of completion of training of the machine learning model based on the second set of randomized solutions including the global minimum of the dataset.

In some examples, to support determining that the second set of randomized solutions includes the global minimum of the dataset, the randomized solution component 530 may be configured to support iteratively generating a set of multiple randomized solutions for a first quantity iterations prior to generating the second set of randomized solutions. In some examples, to support determining that the second set of randomized solutions includes the global minimum of the dataset, the global minimum component 540 may be configured to support determining that the second set of randomized solutions includes the global minimum of the dataset based on the first quantity of iterations satisfying a threshold quantity of iterations.

In some examples, the global minimum component 540 may be configured to support calculating an average change between the first set of randomized solutions and the second set of randomized solutions, where determining that the second set of randomized solutions includes the global minimum of the dataset is based on the average change being less than a threshold level.

In some examples, the loss value component 535 may be configured to support generating the first set of loss values corresponding to the first set of randomized solutions based on computing a loss value for each randomized solution of the first set of randomized solutions using the loss function associated with the dataset.

In some examples, the model parameter component 550 may be configured to support generating a set of updated model parameters for inputting into the machine learning model based on adding one or more deviations to the set of model parameters, where generating the second set of randomized solutions is based on the set of updated model parameters.

In some examples, the second set of randomized solutions is generated within a threshold distance of a search space associated with the first solution. In some examples, the set of model parameters is based on a dimensionality of a search space associated with the machine learning model. In some examples, the machine learning model includes a gradient-based machine learning model.

FIG. 6 shows a diagram of a system 600 including a device 605 that supports an iterative technique to identify global minimum in a dataset in accordance with aspects of the present disclosure. The device 605 may be an example of or include components of a device 405 as described herein. The device 605 may include components for bi-directional data communications including components for transmitting and receiving communications, such as a model training component 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting an iterative technique to identify global minimum in a dataset). The processor 630 may be an example of a single processor or multiple processors. For example, the device 605 may include one or more processors 630.

The model training component 620 may support data processing in accordance with examples as disclosed herein. For example, the model training component 620 may be configured to support receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The model training component 620 may be configured to support generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The model training component 620 may be configured to support selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The model training component 620 may be configured to support generating a second set of randomized solutions based on the first solution and inputting one or more of the set of model parameters into the machine learning model. The model training component 620 may be configured to support determining that the second set of randomized solutions includes a global minimum of the dataset based on the second set of randomized solutions satisfying a threshold. The model training component 620 may be configured to support providing for display, via the interface, an indication of completion of training of the machine learning model based on the second set of randomized solutions including the global minimum of the dataset.

By including or configuring the model training component 620 in accordance with examples as described herein, the device 605 may support techniques for improved reliability, reduced convergence time, and enhanced user experience.

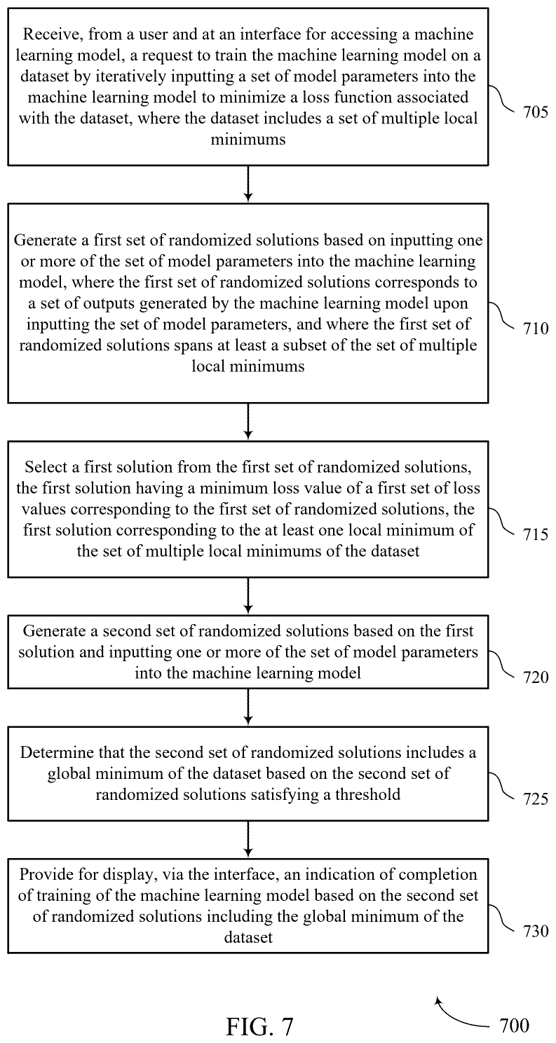

FIG. 7 shows a flowchart illustrating a method 700 that supports an iterative technique to identify global minimum in a dataset in accordance with aspects of the present disclosure. The operations of the method 700 may be implemented by an application server or its components as described herein. For example, the operations of the method 700 may be performed by an application server as described with reference to FIGS. 1 through 6. In some examples, an application server may execute a set of instructions to control the functional elements of the application server to perform the described functions. Additionally, or alternatively, the application server may perform aspects of the described functions using special-purpose hardware.

At 705, the method may include receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The operations of 705 may be performed in accordance with examples as disclosed herein. In some examples, aspects of the operations of 705 may be performed by a request component 525 as described with reference to FIG. 5.

At 710, the method may include generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The operations of 710 may be performed in accordance with examples as disclosed herein. In some examples, aspects of the operations of 710 may be performed by a randomized solution component 530 as described with reference to FIG. 5.

At 715, the method may include selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The operations of 715 may be performed in accordance with examples as disclosed herein. In some examples, aspects of the operations of 715 may be performed by a loss value component 535 as described with reference to FIG. 5.

At 720, the method may include generating a second set of randomized solutions based on the first solution and inputting one or more of the set of model parameters into the machine learning model. The operations of 720 may be performed in accordance with examples as disclosed herein. In some examples, aspects of the operations of 720 may be performed by a randomized solution component 530 as described with reference to FIG. 5.

At 725, the method may include determining that the second set of randomized solutions includes a global minimum of the dataset based on the second set of randomized solutions satisfying a threshold. The operations of 725 may be performed in accordance with examples as disclosed herein. In some examples, aspects of the operations of 725 may be performed by a global minimum component 540 as described with reference to FIG. 5.

At 730, the method may include providing for display, via the interface, an indication of completion of training of the machine learning model based on the second set of randomized solutions including the global minimum of the dataset. The operations of 730 may be performed in accordance with examples as disclosed herein. In some examples, aspects of the operations of 730 may be performed by a display component 545 as described with reference to FIG. 5.

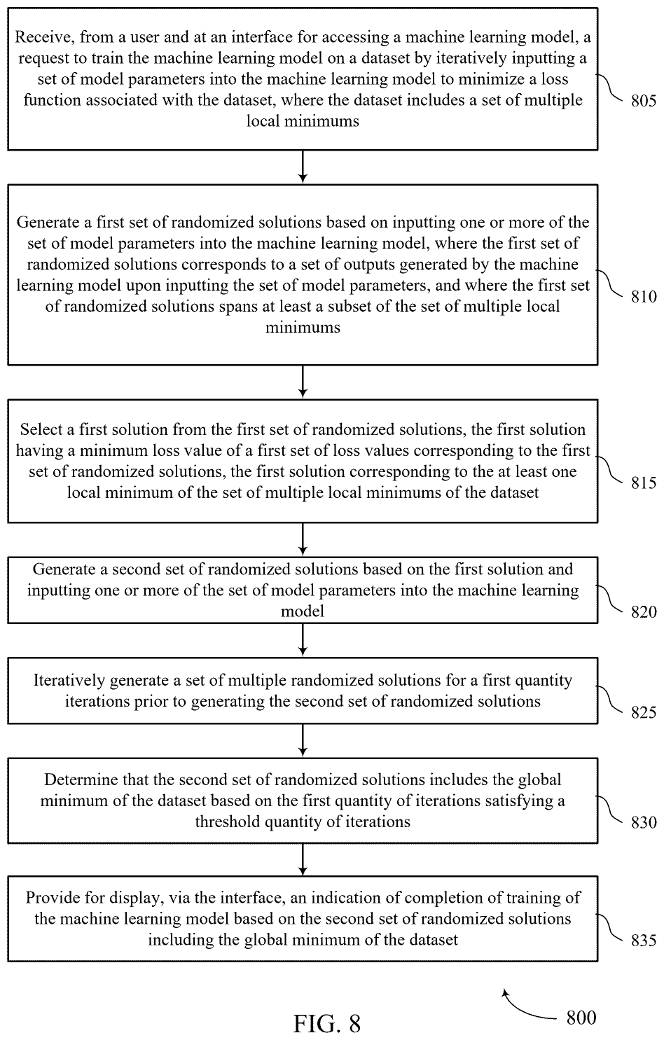

FIG. 8 shows a flowchart illustrating a method 800 that supports an iterative technique to identify global minimum in a dataset in accordance with aspects of the present disclosure. The operations of the method 800 may be implemented by an application server or its components as described herein. For example, the operations of the method 800 may be performed by an application server as described with reference to FIGS. 1 through 6. In some examples, an application server may execute a set of instructions to control the functional elements of the application server to perform the described functions. Additionally, or alternatively, the application server may perform aspects of the described functions using special-purpose hardware.

At 805, the method may include receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The operations of 805 may be performed in accordance with examples as disclosed herein. In some examples, aspects of the operations of 805 may be performed by a request component 525 as described with reference to FIG. 5.

At 810, the method may include generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The operations of 810 may be performed in accordance with examples as disclosed herein. In some examples, aspects of the operations of 810 may be performed by a randomized solution component 530 as described with reference to FIG. 5.

At 815, the method may include selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The operations of 815 may be performed in accordance with examples as disclosed herein. In some examples, aspects of the operations of 815 may be performed by a loss value component 535 as described with reference to FIG. 5.

At 820, the method may include generating a second set of randomized solutions based on the first solution and inputting one or more of the set of model parameters into the machine learning model. The operations of 820 may be performed in accordance with examples as disclosed herein. In some examples, aspects of the operations of 820 may be performed by a randomized solution component 530 as described with reference to FIG. 5.

At 825, the method may include iteratively generating a set of multiple randomized solutions for a first quantity iterations prior to generating the second set of randomized solutions. The operations of 825 may be performed in accordance with examples as disclosed herein. In some examples, aspects of the operations of 825 may be performed by a randomized solution component 530 as described with reference to FIG. 5.

At 830, the method may include determining that the second set of randomized solutions includes the global minimum of the dataset based on the first quantity of iterations satisfying a threshold quantity of iterations. The operations of 830 may be performed in accordance with examples as disclosed herein. In some examples, aspects of the operations of 830 may be performed by a global minimum component 540 as described with reference to FIG. 5.

At 835, the method may include providing for display, via the interface, an indication of completion of training of the machine learning model based on the second set of randomized solutions including the global minimum of the dataset. The operations of 835 may be performed in accordance with examples as disclosed herein. In some examples, aspects of the operations of 835 may be performed by a display component 545 as described with reference to FIG. 5.

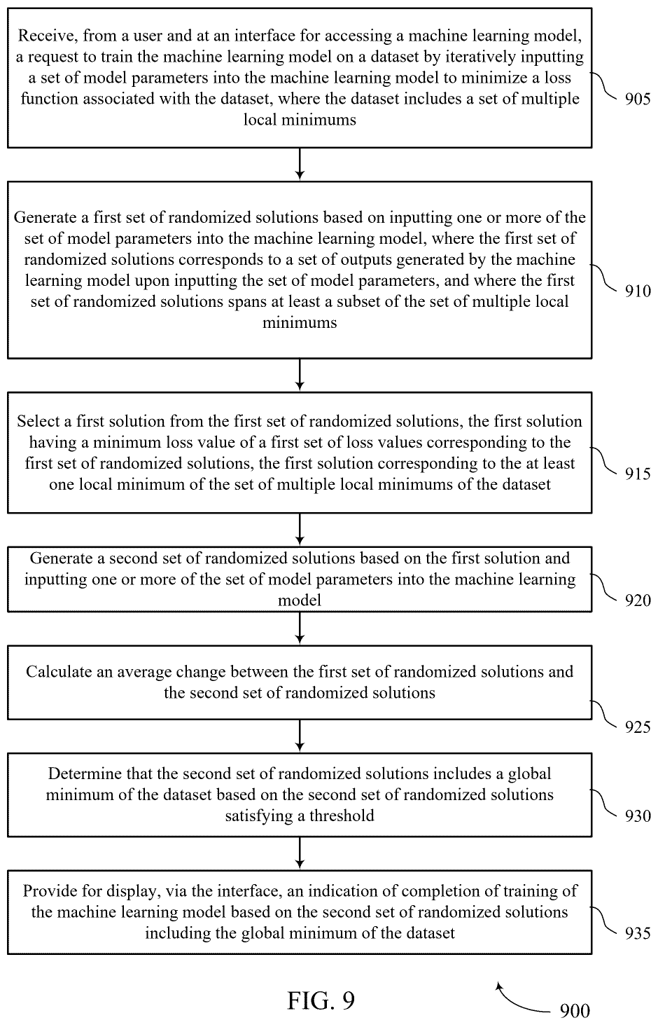

FIG. 9 shows a flowchart illustrating a method 900 that supports an iterative technique to identify global minimum in a dataset in accordance with aspects of the present disclosure. The operations of the method 900 may be implemented by an application server or its components as described herein. For example, the operations of the method 900 may be performed by an application server as described with reference to FIGS. 1 through 6. In some examples, an application server may execute a set of instructions to control the functional elements of the application server to perform the described functions. Additionally, or alternatively, the application server may perform aspects of the described functions using special-purpose hardware.

At 905, the method may include receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The operations of 905 may be performed in accordance with examples as disclosed herein. In some examples, aspects of the operations of 905 may be performed by a request component 525 as described with reference to FIG. 5.

At 910, the method may include generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The operations of 910 may be performed in accordance with examples as disclosed herein. In some examples, aspects of the operations of 910 may be performed by a randomized solution component 530 as described with reference to FIG. 5.

At 915, the method may include selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The operations of 915 may be performed in accordance with examples as disclosed herein. In some examples, aspects of the operations of 915 may be performed by a loss value component 535 as described with reference to FIG. 5.

At 920, the method may include generating a second set of randomized solutions based on the first solution and inputting one or more of the set of model parameters into the machine learning model. The operations of 920 may be performed in accordance with examples as disclosed herein. In some examples, aspects of the operations of 920 may be performed by a randomized solution component 530 as described with reference to FIG. 5.

At 925, the method may include calculating an average change between the first set of randomized solutions and the second set of randomized solutions. The operations of 925 may be performed in accordance with examples as disclosed herein. In some examples, aspects of the operations of 925 may be performed by a global minimum component 540 as described with reference to FIG. 5.

At 930, the method may include determining that the second set of randomized solutions includes a global minimum of the dataset based on the second set of randomized solutions satisfying a threshold. In some cases, determining that the second set of randomized solutions includes the global minimum of the dataset is based on the average change being less than a threshold level. The operations of 930 may be performed in accordance with examples as disclosed herein. In some examples, aspects of the operations of 930 may be performed by a global minimum component 540 as described with reference to FIG. 5.

At 935, the method may include providing for display, via the interface, an indication of completion of training of the machine learning model based on the second set of randomized solutions including the global minimum of the dataset. The operations of 935 may be performed in accordance with examples as disclosed herein. In some examples, aspects of the operations of 935 may be performed by a display component 545 as described with reference to FIG. 5.

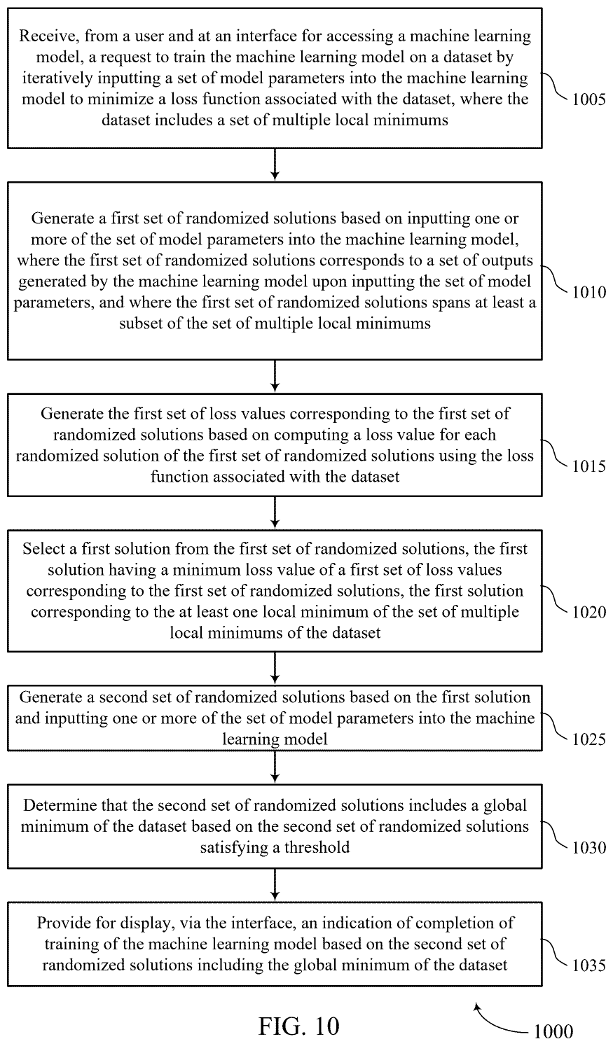

FIG. 10 shows a flowchart illustrating a method 1000 that supports an iterative technique to identify global minimum in a dataset in accordance with aspects of the present disclosure. The operations of the method 1000 may be implemented by an application server or its components as described herein. For example, the operations of the method 1000 may be performed by an application server as described with reference to FIGS. 1 through 6. In some examples, an application server may execute a set of instructions to control the functional elements of the application server to perform the described functions. Additionally, or alternatively, the application server may perform aspects of the described functions using special-purpose hardware.

At 1005, the method may include receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums. The operations of 1005 may be performed in accordance with examples as disclosed herein. In some examples, aspects of the operations of 1005 may be performed by a request component 525 as described with reference to FIG. 5.

At 1010, the method may include generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums. The operations of 1010 may be performed in accordance with examples as disclosed herein. In some examples, aspects of the operations of 1010 may be performed by a randomized solution component 530 as described with reference to FIG. 5.

At 1015, the method may include generating the first set of loss values corresponding to the first set of randomized solutions based on computing a loss value for each randomized solution of the first set of randomized solutions using the loss function associated with the dataset. The operations of 1015 may be performed in accordance with examples as disclosed herein. In some examples, aspects of the operations of 1015 may be performed by a loss value component 535 as described with reference to FIG. 5.

At 1020, the method may include selecting a first solution from the first set of randomized solutions, the first solution having a minimum loss value of a first set of loss values corresponding to the first set of randomized solutions, the first solution corresponding to the at least one local minimum of the set of multiple local minimums of the dataset. The operations of 1020 may be performed in accordance with examples as disclosed herein. In some examples, aspects of the operations of 1020 may be performed by a loss value component 535 as described with reference to FIG. 5.

At 1025, the method may include generating a second set of randomized solutions based on the first solution and inputting one or more of the set of model parameters into the machine learning model. The operations of 1025 may be performed in accordance with examples as disclosed herein. In some examples, aspects of the operations of 1025 may be performed by a randomized solution component 530 as described with reference to FIG. 5.

At 1030, the method may include determining that the second set of randomized solutions includes a global minimum of the dataset based on the second set of randomized solutions satisfying a threshold. The operations of 1030 may be performed in accordance with examples as disclosed herein. In some examples, aspects of the operations of 1030 may be performed by a global minimum component 540 as described with reference to FIG. 5.

At 1035, the method may include providing for display, via the interface, an indication of completion of training of the machine learning model based on the second set of randomized solutions including the global minimum of the dataset. The operations of 1035 may be performed in accordance with examples as disclosed herein. In some examples, aspects of the operations of 1035 may be performed by a display component 545 as described with reference to FIG. 5.

A method for data processing by an apparatus is described. The method may include receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums, generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums, selecting a first solution from the first set of randomized solutions, the first solution having a minimum loss value of a first set of loss values corresponding to the first set of randomized solutions, the first solution corresponding to the at least one local minimum of the set of multiple local minimums of the dataset, generating a second set of randomized solutions based on the first solution and inputting one or more of the set of model parameters into the machine learning model, determining that the second set of randomized solutions includes a global minimum of the dataset based on the second set of randomized solutions satisfying a threshold, and providing for display, via the interface, an indication of completion of training of the machine learning model based on the second set of randomized solutions including the global minimum of the dataset.

An apparatus for data processing is described. The apparatus may include one or more memories storing processor executable code, and one or more processors coupled with the one or more memories. The one or more processors may individually or collectively be operable to execute the code to cause the apparatus to receive, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums, generate a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums, select a first solution from the first set of randomized solutions, the first solution having a minimum loss value of a first set of loss values corresponding to the first set of randomized solutions, the first solution corresponding to the at least one local minimum of the set of multiple local minimums of the dataset, generate a second set of randomized solutions based on the first solution and inputting one or more of the set of model parameters into the machine learning model, determine that the second set of randomized solutions includes a global minimum of the dataset based on the second set of randomized solutions satisfying a threshold, and provide for display, via the interface, an indication of completion of training of the machine learning model based on the second set of randomized solutions including the global minimum of the dataset.

Another apparatus for data processing is described. The apparatus may include means for receiving, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums, means for generating a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums, means for selecting a first solution from the first set of randomized solutions, the first solution having a minimum loss value of a first set of loss values corresponding to the first set of randomized solutions, the first solution corresponding to the at least one local minimum of the set of multiple local minimums of the dataset, means for generating a second set of randomized solutions based on the first solution and inputting one or more of the set of model parameters into the machine learning model, means for determining that the second set of randomized solutions includes a global minimum of the dataset based on the second set of randomized solutions satisfying a threshold, and means for providing for display, via the interface, an indication of completion of training of the machine learning model based on the second set of randomized solutions including the global minimum of the dataset.

A non-transitory computer-readable medium storing code for data processing is described. The code may include instructions executable by one or more processors to receive, from a user and at an interface for accessing a machine learning model, a request to train the machine learning model on a dataset by iteratively inputting a set of model parameters into the machine learning model to minimize a loss function associated with the dataset, where the dataset includes a set of multiple local minimums, generate a first set of randomized solutions based on inputting one or more of the set of model parameters into the machine learning model, where the first set of randomized solutions corresponds to a set of outputs generated by the machine learning model upon inputting the set of model parameters, and where the first set of randomized solutions spans at least a subset of the set of multiple local minimums, select a first solution from the first set of randomized solutions, the first solution having a minimum loss value of a first set of loss values corresponding to the first set of randomized solutions, the first solution corresponding to the at least one local minimum of the set of multiple local minimums of the dataset, generate a second set of randomized solutions based on the first solution and inputting one or more of the set of model parameters into the machine learning model, determine that the second set of randomized solutions includes a global minimum of the dataset based on the second set of randomized solutions satisfying a threshold, and provide for display, via the interface, an indication of completion of training of the machine learning model based on the second set of randomized solutions including the global minimum of the dataset.

In some examples of the method, apparatus, and non-transitory computer-readable medium described herein, determining that the second set of randomized solutions includes the global minimum of the dataset may include operations, features, means, or instructions for iteratively generating a set of multiple randomized solutions for a first quantity iterations prior to generating the second set of randomized solutions and determining that the second set of randomized solutions includes the global minimum of the dataset based on the first quantity of iterations satisfying a threshold quantity of iterations.

Some examples of the method, apparatus, and non-transitory computer-readable medium described herein may further include operations, features, means, or instructions for calculating an average change between the first set of randomized solutions and the second set of randomized solutions, where determining that the second set of randomized solutions includes the global minimum of the dataset may be based on the average change being less than a threshold level.

Some examples of the method, apparatus, and non-transitory computer-readable medium described herein may further include operations, features, means, or instructions for generating the first set of loss values corresponding to the first set of randomized solutions based on computing a loss value for each randomized solution of the first set of randomized solutions using the loss function associated with the dataset.

Some examples of the method, apparatus, and non-transitory computer-readable medium described herein may further include operations, features, means, or instructions for generating a set of updated model parameters for inputting into the machine learning model based on adding one or more deviations to the set of model parameters, where generating the second set of randomized solutions may be based on the set of updated model parameters.

In some examples of the method, apparatus, and non-transitory computer-readable medium described herein, the second set of randomized solutions may be generated within a threshold distance of a search space associated with the first solution.

In some examples of the method, apparatus, and non-transitory computer-readable medium described herein, the set of model parameters may be based on a dimensionality of a search space associated with the machine learning model.

In some examples of the method, apparatus, and non-transitory computer-readable medium described herein, the machine learning model includes a gradient-based machine learning model.

The following provides an overview of aspects of the present disclosure:
Aspect 1: A method for data processing, comprising: receiving, from a user and at an interface for accessing a machine learning model, a request to train the machine learning model on a dataset by iteratively inputting a set of model parameters into the machine learning model to minimize a loss function associated with the dataset, wherein the dataset comprises a plurality of local minimums; generating a first set of randomized solutions based at least in part on inputting one or more of the set of model parameters into the machine learning model, wherein the first set of randomized solutions corresponds to a set of outputs generated by the machine learning model upon inputting the set of model parameters, and wherein the first set of randomized solutions spans at least a subset of the plurality of local minimums; selecting a first solution from the first set of randomized solutions, the first solution having a minimum loss value of a first set of loss values corresponding to the first set of randomized solutions, the first solution corresponding to the at least one local minimum of the plurality of local minimums of the dataset; generating a second set of randomized solutions based at least in part on the first solution and inputting one or more of the set of model parameters into the machine learning model; determining that the second set of randomized solutions comprises a global minimum of the dataset based at least in part on the second set of randomized solutions satisfying a threshold; and providing for display, via the interface, an indication of completion of training of the machine learning model based at least in part on the second set of randomized solutions comprising the global minimum of the dataset.
Aspect 2: The method of aspect 1, wherein determining that the second set of randomized solutions comprises the global minimum of the dataset further comprises: iteratively generating a plurality of randomized solutions for a first quantity iterations prior to generating the second set of randomized solutions; and determining that the second set of randomized solutions comprises the global minimum of the dataset based at least in part on the first quantity of iterations satisfying a threshold quantity of iterations.
Aspect 3: The method of any of aspects 1 through 2, further comprising: calculating an average change between the first set of randomized solutions and the second set of randomized solutions, wherein determining that the second set of randomized solutions comprises the global minimum of the dataset is based at least in part on the average change being less than a threshold level.
Aspect 4: The method of any of aspects 1 through 3, further comprising: generating the first set of loss values corresponding to the first set of randomized solutions based at least in part on computing a loss value for each randomized solution of the first set of randomized solutions using the loss function associated with the dataset.
Aspect 5: The method of any of aspects 1 through 4, further comprising: generating a set of updated model parameters for inputting into the machine learning model based at least in part on adding one or more deviations to the set of model parameters, wherein generating the second set of randomized solutions is based at least in part on the set of updated model parameters.
Aspect 6: The method of any of aspects 1 through 5, wherein the second set of randomized solutions is generated within a threshold distance of a search space associated with the first solution.
Aspect 7: The method of any of aspects 1 through 6, wherein the set of model parameters is based at least in part on a dimensionality of a search space associated with the machine learning model.
Aspect 8: The method of any of aspects 1 through 7, wherein the machine learning model comprises a gradient-based machine learning model.
Aspect 9: An apparatus for data processing, comprising one or more memories storing processor-executable code, and one or more processors coupled with the one or more memories and individually or collectively operable to execute the code to cause the apparatus to perform a method of any of aspects 1 through 8.
Aspect 10: An apparatus for data processing, comprising at least one means for performing a method of any of aspects 1 through 8.
Aspect 11: A non-transitory computer-readable medium storing code for data processing, the code comprising instructions executable by one or more processors to perform a method of any of aspects 1 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, from a user and at an interface for accessing a machine learning model, a request to train the machine learning model on a dataset by iteratively inputting a set of model parameters into the machine learning model to minimize a loss function associated with the dataset, wherein the dataset comprises a plurality of local minimums;
generating a first set of randomized solutions based at least in part on inputting one or more of the set of model parameters into the machine learning model, wherein the first set of randomized solutions corresponds to a set of outputs generated by the machine learning model upon inputting the set of model parameters, and wherein the first set of randomized solutions spans at least a subset of the plurality of local minimums;
selecting a first solution from the first set of randomized solutions, the first solution having a minimum loss value of a first set of loss values corresponding to the first set of randomized solutions, the first solution corresponding to the at least one local minimum of the plurality of local minimums of the dataset;
generating a second set of randomized solutions based at least in part on the first solution and inputting one or more of the set of model parameters into the machine learning model;
determining that the second set of randomized solutions comprises a global minimum of the dataset based at least in part on the second set of randomized solutions satisfying a threshold; and
providing for display, via the interface, an indication of completion of training of the machine learning model based at least in part on the second set of randomized solutions comprising the global minimum of the dataset.

2. The method of claim 1, wherein determining that the second set of randomized solutions comprises the global minimum of the dataset further comprises:
iteratively generating a plurality of randomized solutions for a first quantity iterations prior to generating the second set of randomized solutions; and
determining that the second set of randomized solutions comprises the global minimum of the dataset based at least in part on the first quantity of iterations satisfying a threshold quantity of iterations.

3. The method of claim 1, further comprising:
calculating an average change between the first set of randomized solutions and the second set of randomized solutions, wherein determining that the second set of randomized solutions comprises the global minimum of the dataset is based at least in part on the average change being less than a threshold level.

4. The method of claim 1, further comprising:
generating the first set of loss values corresponding to the first set of randomized solutions based at least in part on computing a loss value for each randomized solution of the first set of randomized solutions using the loss function associated with the dataset.

5. The method of claim 1, further comprising:
generating a set of updated model parameters for inputting into the machine learning model based at least in part on adding one or more deviations to the set of model parameters, wherein generating the second set of randomized solutions is based at least in part on the set of updated model parameters.

6. The method of claim 1, wherein the second set of randomized solutions is generated within a threshold distance of a search space associated with the first solution.

7. The method of claim 1, wherein the set of model parameters is based at least in part on a dimensionality of a search space associated with the machine learning model.

8. The method of claim 1, wherein the machine learning model comprises a gradient-based machine learning model.

9. An apparatus for data processing, comprising:
one or more memories storing processor-executable code; and
one or more processors coupled with the one or more memories and individually or collectively operable to execute the code to cause the apparatus to:
receive, from a user and at an interface for accessing a machine learning model, a request to train the machine learning model on a dataset by iteratively inputting a set of model parameters into the machine learning model to minimize a loss function associated with the dataset, wherein the dataset comprises a plurality of local minimums;
generate a first set of randomized solutions based at least in part on inputting one or more of the set of model parameters into the machine learning model, wherein the first set of randomized solutions corresponds to a set of outputs generated by the machine learning model upon inputting the set of model parameters, and wherein the first set of randomized solutions spans at least a subset of the plurality of local minimums;
select a first solution from the first set of randomized solutions, the first solution having a minimum loss value of a first set of loss values corresponding to the first set of randomized solutions, the first solution corresponding to the at least one local minimum of the plurality of local minimums of the dataset;
generate a second set of randomized solutions based at least in part on the first solution and inputting one or more of the set of model parameters into the machine learning model;
determine that the second set of randomized solutions comprises a global minimum of the dataset based at least in part on the second set of randomized solutions satisfying a threshold; and
provide for display, via the interface, an indication of completion of training of the machine learning model based at least in part on the second set of randomized solutions comprising the global minimum of the dataset.

10. The apparatus of claim 9, wherein, to determine that the second set of randomized solutions comprises the global minimum of the dataset, the one or more processors are individually or collectively further operable to execute the code to cause the apparatus to:
iteratively generate a plurality of randomized solutions for a first quantity iterations prior to generating the second set of randomized solutions; and
determine that the second set of randomized solutions comprises the global minimum of the dataset based at least in part on the first quantity of iterations satisfying a threshold quantity of iterations.

11. The apparatus of claim 9, wherein the one or more processors are individually or collectively further operable to execute the code to cause the apparatus to:
calculate an average change between the first set of randomized solutions and the second set of randomized solutions, wherein determining that the second set of randomized solutions comprises the global minimum of the dataset is based at least in part on the average change being less than a threshold level.

12. The apparatus of claim 9, wherein the one or more processors are individually or collectively further operable to execute the code to cause the apparatus to:
generate the first set of loss values corresponding to the first set of randomized solutions based at least in part on computing a loss value for each randomized solution of the first set of randomized solutions using the loss function associated with the dataset.

13. The apparatus of claim 9, wherein the one or more processors are individually or collectively further operable to execute the code to cause the apparatus to:
generate a set of updated model parameters for inputting into the machine learning model based at least in part on adding one or more deviations to the set of model parameters, wherein generating the second set of randomized solutions is based at least in part on the set of updated model parameters.

14. The apparatus of claim 9, wherein the second set of randomized solutions is generated within a threshold distance of a search space associated with the first solution.

15. The apparatus of claim 9, wherein the set of model parameters is based at least in part on a dimensionality of a search space associated with the machine learning model.

16. The apparatus of claim 9, wherein the machine learning model comprises a gradient-based machine learning model.

17. A non-transitory computer-readable medium storing code for data processing, the code comprising instructions executable by one or more processors to:
receive, from a user and at an interface for accessing a machine learning model, a request to train the machine learning model on a dataset by iteratively inputting a set of model parameters into the machine learning model to minimize a loss function associated with the dataset, wherein the dataset comprises a plurality of local minimums;
generate a first set of randomized solutions based at least in part on inputting one or more of the set of model parameters into the machine learning model, wherein the first set of randomized solutions corresponds to a set of outputs generated by the machine learning model upon inputting the set of model parameters, and wherein the first set of randomized solutions spans at least a subset of the plurality of local minimums;
select a first solution from the first set of randomized solutions, the first solution having a minimum loss value of a first set of loss values corresponding to the first set of randomized solutions, the first solution corresponding to the at least one local minimum of the plurality of local minimums of the dataset;
generate a second set of randomized solutions based at least in part on the first solution and inputting one or more of the set of model parameters into the machine learning model;
determine that the second set of randomized solutions comprises a global minimum of the dataset based at least in part on the second set of randomized solutions satisfying a threshold; and
provide for display, via the interface, an indication of completion of training of the machine learning model based at least in part on the second set of randomized solutions comprising the global minimum of the dataset.

18. The non-transitory computer-readable medium of claim 17, wherein the instructions to determine that the second set of randomized solutions comprises the global minimum of the dataset are further executable by the one or more processors to:
iteratively generate a plurality of randomized solutions for a first quantity iterations prior to generating the second set of randomized solutions; and
determine that the second set of randomized solutions comprises the global minimum of the dataset based at least in part on the first quantity of iterations satisfying a threshold quantity of iterations.

19. The non-transitory computer-readable medium of claim 17, wherein the instructions are further executable by the one or more processors to:
calculate an average change between the first set of randomized solutions and the second set of randomized solutions, wherein determining that the second set of randomized solutions comprises the global minimum of the dataset is based at least in part on the average change being less than a threshold level.

20. The non-transitory computer-readable medium of claim 17, wherein the instructions are further executable by the one or more processors to:
generate the first set of loss values corresponding to the first set of randomized solutions based at least in part on computing a loss value for each randomized solution of the first set of randomized solutions using the loss function associated with the dataset.
